(19) United States
(12) Patent Application Publication
(10) Pub. No.: US 2018/0093115 A1
(43) Pub. Date: Apr. 5, 2018

(54) Fire extinguishing support beams for storage racks

(71) Applicant: GelTech Solutions, Inc., Jupiter, FL (US)

(72) Inventor: Peter Cordani, Palm Beach Gardens, FL (US)

(21) Appl. No.: 15/720,473

(22) Filed: Sep. 29, 2017

Related U.S. Application Data
(60) Provisional application No. 62/402,025, filed on Sep. 30, 2016.

(51) Int. Cl. A62C 3/00; A62C 35/60; A62C 35/64

(52) U.S. Cl. CPC A62C 3/002; A62C 35/645; A62C 35/60

(57) ABSTRACT

An apparatus suppressing the spread of and extinguishing fires in the confined areas of storage racks. Select support beams of the storage rack include a pressurized fire extinguishing mixture. Spray nozzles are secured to each support beam, each nozzle having a temperature activated release that allows distribution of the fire extinguishing mixture stored with the support beam upon the presence of high heat. Each support beam is self contained, wherein a conventional support beam can be exchanged for a fire extinguishing support beam without modification of the remainder of the storage rack system. In a preferred embodiment, the fire extinguishing material is a hydrated polymer forming superior fire suppression and extinguishing properties with the ability to cling to the objects to which it has been applied.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 62/402,025, entitled “FIRE EXTINGUISHING SUPPORT BEAMS FOR STORAGE RACKS”, filed Sep. 30, 2016. The contents of which the above referenced application is incorporated herein by reference.

### FIELD OF THE INVENTION

This invention relates to the field of fire prevention; and more particularly, to a method of using a dehydrated super absorbent polymer in combination with a source of water to extinguish electrical fires. More specifically, this invention describes a method of extinguishing and suppressing the rekindling of electrical fires on storage racks such as those found in retail stores.

### BACKGROUND OF THE INVENTION

Retail stores display their wares on shelves commonly referred to as storage racks. In many cases, the larger the store, the more storage racks are employed, both in width and height. Larger racks allow for the support of larger amounts of inventory. The United States is filled with stores referred to as “big box retailers”. These retailers carry an immense amount of product to address the large volume of people that frequent the retailers and seek instant gratification of their product requirements. For instance, furniture stores may have sofas, tables, cabinets and the like furniture stored on the racks. Home improvement stores are filled with various types of lumber stacked on the racks, anything from fence posts to basic home building supplies such as studs, plywood and drywall sheets. The weight of these supplies can be tremendous; just 30 pieces of ⅝″ plywood can weight nearly 2,000 pounds. Such big-box stores may have upwards of seven racks stacked above one another, leading to a tremendous amount of weight and, more critically, what could be considered fuel ina fire.

While the ability of racks being able to carry large amounts of product has been a benefit to retailers, it also poses a unique fire risk. The previously mentioned use of a rack for storing plywood exemplifies the situation. Racks filled with furniture are yet another example of a product that can fuel a fire. Most every product that is shipped is protected by some form of cardboard material. In each of these situations, should a fire occur within a storage rack, the conventional ceiling mounted fire extinguishing system is ineffective. The design of the storage racks employs multiple tiers; therefore, lower tiers are essentially concealed from ceiling mounted sprinkler systems. Left unprotected, a fire can build within the confines of the lower tiers of the storage rack. It is well known that the most opportune moment in which to extinguish a fire is at the time of creation. The current design of stacked storage racks fails to address this problem.

Thus, what is needed in the field is a method of extinguishing fires that occur within lower tiers of a storage rack to provide timely extinguishing of a fire.

### DESCRIPTION OF THE PRIOR ART

U.S. Pat. Nos. 5,386,917 and 5,636,755 discloses a storage rack system with a fire extinguishing device, The rack system includes a horizontally extending beam located in a fixed position at a predetermined elevation above a support surface. An outer wall of the beam defines an inclined surface at an angle from about 10 degrees to about 80 degrees relative to a vertical plane. A vane is mounted to the beam, generally parallel to the beam. A fire extinguishing device is spaced horizontally from the inclined surface and located in a fixed position relative to the storage rack, such that, when the fire extinguishing device is discharging fluid, the inclined surface deflects the fluid against the surface of the beam.

U.S. Pat. No. 3,539,108 describes a storage rack and sprinkler arrangement wherein vertical tubular supports, having spaced sprinkler heads or sprinkler headers thereon, vertically support the racks while simultaneously conveying fire extinguishing liquid to the sprinkler heads and cooling the vertical supports to resist collapse thereof when the structural supports are exposed to fire.

U.S. Pat. No. 3,727,694 discloses a sprinkler attachment for use with knockdown racks of the type having a plurality of slotted upright posts connected by horizontal cross members. The sprinkler apparatus includes a vertical sprinkler pipe fastened to a pair of connecting brace members which bridge and connect to at least two of the upright posts. The sprinkler pipe has a plurality of sprinkler heads extending therefrom, and carries inlet coupling means which are adapted for coupling fluid flow conduit to the sprinkler pipe.

U.S. Pat. No. 4,418,757 describes an improved warehouse stacker rack in which the sprinkler system is an integrated portion of a rack structure. A plurality of load bearing side frame members of any given height are operably interconnected to provide a stable structure having a plurality of load receiving cells. The sprinkler system is comprised of a plurality of pipe members, each having a length, such that, when assembled to connect a pair of side frame members, a load receiving cell of a predetermined width is created. A clamp for providing limited tri-axial movement of a sprinkler pipe is disposed on each of the side frame members and is adapted to co-act with the end of a sprinkler pipe to operably engage the same, and to horizontally space the side frame members while permitting vertical and horizontal misalignment to accommodate normal construction tolerances. The clamps are also configured and arranged to provide integrity to the sprinkler system by shielding the connections at the ends of the individual pipes from damage due to accidental contact.

U.S. Pat. No. 4,484,634 provides a flexible rigid conduit system particularly suitable for fire protection sprinkler installations usable with movable storage racks wherein a plurality of rigid conduits are interconnected by self-aligning rotary joints permitting pressurized water to be supplied to the storage rack regardless of its location. The conduit system is supported remotely of its fixed portions by a track and carriage arrangement providing support for the conduits and permitting unhindered movement thereof.

U.S. Patent Application Publication No. 2015/0027739 provides a fire protection sprinkler system for the protection of commodities stored in a plurality of adjoining racks having a longitudinal flue space between the racks. The system includes at least one fluid supply conduit in fluid communication with a source of a fire protection fluid. The system also includes at least one solid horizontal barrier covering each rack and the longitudinal flue space at a predetermined vertical spacing. The system further includes one or more rack-level fire protection sprinklers in fluid communication with the fluid supply. The sprinklers are disposed in the vertical flue space between adjacent horizontal barriers, and each sprinkler is spaced vertically from the commodities stored between adjacent horizontal barriers.

U.S. Pat. No. 7,124,834 discloses a method for extinguishing a fire in a space such as a tunnel. The method includes spraying a fire extinguishing medium into the space with spray heads. In a first stage of the method, the flow and temperature of the hot gases produced by the fire are influenced by spraying an extinguishing medium into the space, especially by creating at least one curtain of extinguishing medium in the space. At least some spray heads in the space are pre-activated into a state of readiness. In a second stage method, at least one spraying head is activated to produce a spray of extinguishing medium.

U.S. Pat. No. 5,190,110 discloses the fighting of fires or protection of objects from fire by applying water which comprises dispersing in the water particles of a cross-linked, water-insoluble, but highly water-swellable, acrylic acid derivative polymer. The particles are present in an amount such that, after swelling, the swollen particles hold 60% to 70% by weight of the total water; the polymer being a copolymer of an acrylic acid, the water containing silicic acid and/or a silicate as well as sodium, potassium or ammonium ions. The water is freely pumpable, but the swollen particles adhere to surfaces they contact rather than running off rapidly.

U.S. Pat. No. 5,849,210 discloses a method of preventing or retarding a combustible object from burning, including the steps of mixing water with a super absorbent polymer (“SAP”) to form one at least partially hydrated SAP, and applying the at least partially hydrated SAP to the combustible object, before or after combustion. In another embodiment, an article of manufacture includes a SAP that is prehydrated and is useful for preventing a combustible object from burning, or preventing penetration of extreme heat or fire to a firefighter or other animal.

U.S. Pat. No. 4,978,460 discloses a particulate additive for water for fire fighting containing a strongly swelling water-insoluble high molecular weight polymer as a gelatinizing agent, which comprises a water-soluble release agent Which does not cause the particles of said gelatinizing agent to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

U.S. Pat. No. 5,519,088 discloses an aqueous gel comprising a polymer of (meth)acrylamide or particular (meth)acrylamide derivative(s), particulate metal oxide(s) and an aqueous medium, a process for producing said gel, and products utilizing said gel. This aqueous gel can be produced so as to have transparency, be highly elastic and fire resistant, and can prevent the spreading of flames. The aqueous gel, when produced transparent, becomes cloudy when heated or cooled and is useful for the shielding of heat rays or cold radiation.

### SUMMARY OF THE INVENTION

A method for suppressing the spread of and extinguishing fires in confined areas, namely storage racks. The method employs a fire extinguishing apparatus that is incorporated into the storage beams that form the foundation for the racks. Each storage beam may include the self contained fire extinguishing apparatus so as to provide point of fire application when needed. Each storage beam is filled with a fire extinguishing composition and pressurized with a compressed gas. Spray nozzles are positioned along the length of the storage beam, each nozzle including a temperature active release mechanism. The storage beam includes a sealable fill port and pressure indicator. Incorporation of the fire extinguishing composition eliminates the need for coupling additional cylinders to the structure, making it easier to ship and install, and eliminates the possibility of the accidental dislodgement of a fire extinguishing cylinder.

Most any fire extinguishing material may be applied. In a preferred embodiment, a mixture of super absorbent polymer and water forms an admixture that forms a superior fire suppressant, and does not present a danger to personnel, as the admixture is non-conductive. One of the unique properties of the admixture is its ability to cling to the object(s) to which it has been applied to both cool down the object(s) after it is on fire and block the fire from reaching the object(s). The admixture also has a viscosity which enables it to be contained within a specific area without spreading to adjacent areas. These superior properties enable fires to be extinguished more rapidly, and will not lead to the destruction of adjoining product. Depending upon the product that caught fire, toxic gases can be released from materials such as plastic. The super absorbent polymer and water admixture also encapsulates the noxious and toxic gases produced by fires and prevents the release of these toxic gases into the atmosphere. The super absorbent polymer and water mixture retains the ash, particulates, and other by-products of a fire to enable a rapid and thorough cleanup.

Accordingly, it is an objective of the present invention to provide a support beam having a dual function of forming the foundation for storage racks as well as providing an apparatus for extinguishing and suppressing the spread of fires within storage racks.

It is yet another objective of the present invention to provide a unique method of extinguishing fires and suppressing the spread of fires which utilizes substantially less water, resulting in less damage to other product located in the vicinity of the fire.

It is still yet another objective of the present invention to disclose an admixture of super absorbent polymer and water which has viscosity sufficient to enable it to adhere to horizontal, vertical, inclined, and curved surfaces.

It is a still further objective of the present invention provide a point of fire apparatus for suppressing the spread of and extinguishing fires more rapidly.

It is a still further objective of the present invention to provide a unique method of extinguishing fires which addresses noxious and toxic gases that may be released by a fire.

It is a still further objective of the present invention to provide a unique method of extinguishing fires which results in a rapid and less expensive cleanup process.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of cantilevered storage racks including the fire extinguishing system of the instant invention;

FIG. 2 is a front view of FIG. 1;

FIG. 3 is a side view of FIG. 2;

FIG. 4 is a perspective view of horizontally disposed storage racks including the fire extinguishing system of the instant invention;

FIG. 5 is a front view of FIG. 4;

FIG. 6 is a side view of FIG. 5.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to a unique technique or method of extinguishing fires and suppressing the spread of fires in the confines of a storage rack installation. This invention addresses the problem of how the confines of an individual storage rack inhibit a conventional ceiling mounted sprinkler system from effectively reaching a fire that starts in a covered tier. Most modern code regulations require stores to include a ceiling mounted sprinkler system to confront a fire; however, only the top tier of the storage rack would receive the full benefit of the sprinkler system. The upper tier is the only level directly exposed to the ceiling mounted sprinkling system, as the lower tiers are shielded from the ceiling sprinklers by the upper tier and by storage stacks placed on either side of the individual rack.

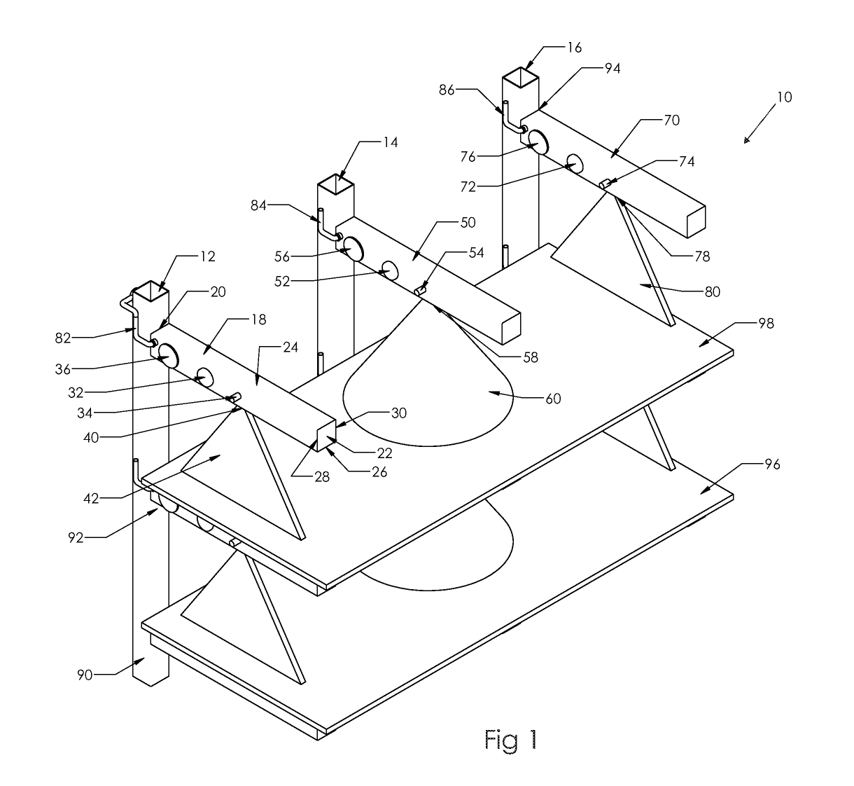

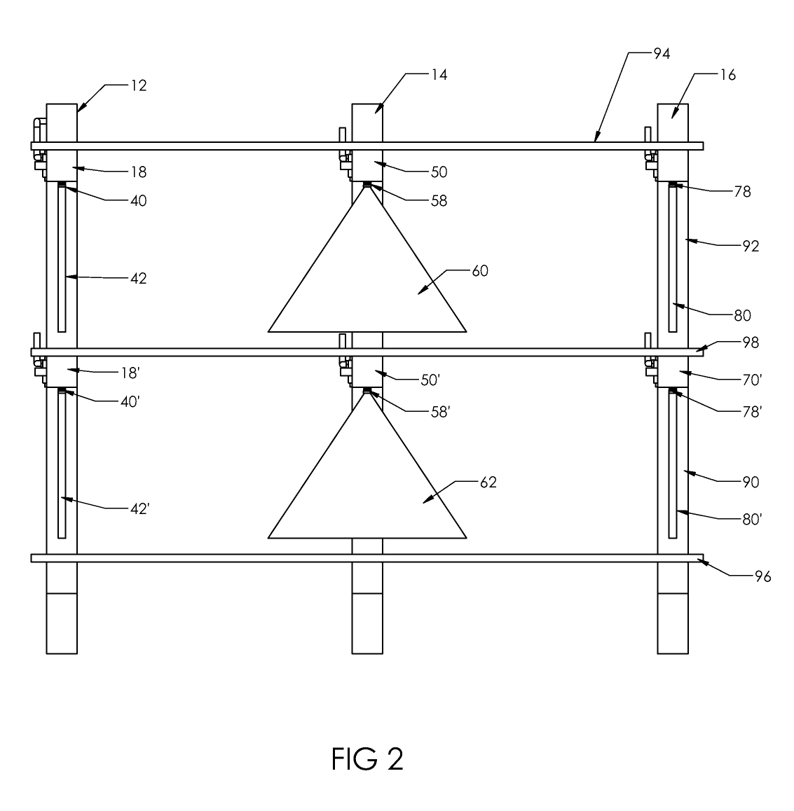

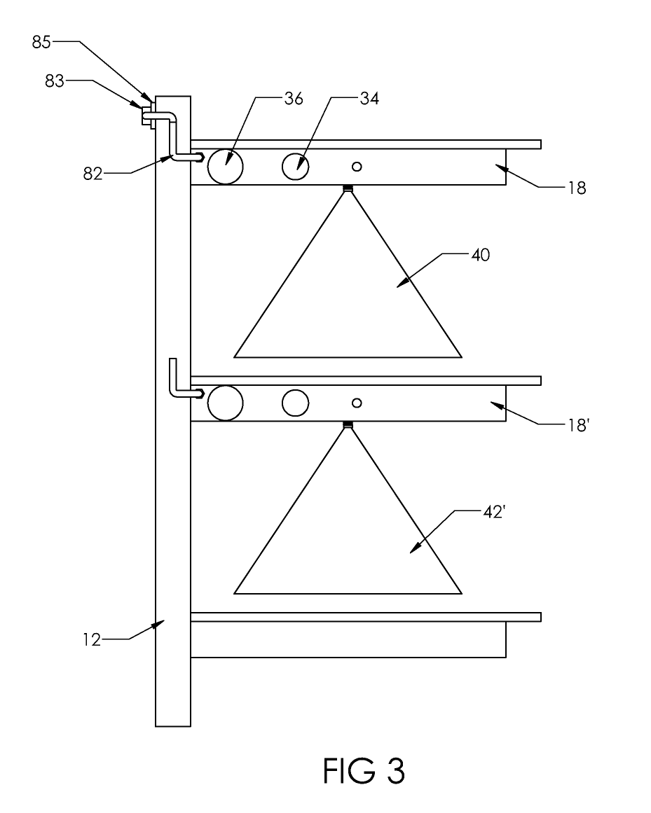

Referring now to FIGS. 1 through 3, set forth is a first embodiment of the invention depicting a storage rack 10 having a first vertical upright 12, a second vertical upright 14 and a third vertical upright 16. The first vertical upright 12 has an adjustable cantilever support beam 18 characterized by a first end 20 which is releasably secured to the first upright 12, and a second end 22 spaced apart from the first end 20 with an internal chamber formed by a top wall 24, a bottom wail 26, left side wall 28 and right side wall 30. The walls and end form a hollow chamber therein, which is accessible by a fill port 32 that allows insertion of a fire extinguishing mixture within the chamber. The fill port 32 is preferably a threadable plug capable of sealing the chamber. The chamber is pressurized through air valve 34 to compress the fire extinguishing material to a predetermined level as measured by pressure gauge 36.

A spray nozzle 40 is secured to the bottom wall 26 of the support beam 18 and fluidly communicated with the chamber. The spray nozzle 40 includes a temperature sensitive element that allows release of the pressurized fire extinguishing material in an adjustable spray pattern, such as the fan spray depicted by numeral 42. The nozzles employed are constructed and arranged to vent at a predetermined temperature from 158° F. to 350° F. The vent is based upon a fusible element that releases at a predetermined temperature. The vent can be based upon the NFPA #13 regarding fire sprinkler design guidelines. The spray nozzle 40 can be adjusted to produce a fan or conical shaped spray to address the type of materials stored on the tier of the storage rack. Similarly, the second upright 14 is shown with a second support beam 50 having a fill port 52 for insertion of fire extinguishing material within an internal chamber formed within the support beam, similar to the first support beam 18. Air valve 54 allows for pressurization of the fire extinguishing mixture to an expulsion pressure as depicted by pressure gauge 56. In this configuration, spray nozzle 58 depicts a conical spray 60 as opposed to the fan spray 42. Unique to this invention is the ability to place the self contained support beams as needed, wherein some tiers may not need fire suppression requirements. In this manner, a company can be selective in placement of the tire extinguishing support beams. Further to this illustration, upright 16 depicts the third support beam 70, again with a self-contained fire extinguishing medium inserted into the support beam 70 by accessing fill port 72, pressurizing the fire extinguishing media with air valve 74 to a desired pressure, as indicated by pressure gauge 76. In this embodiment, the spray nozzle 78 provides a fan spray 80, which operates as a blanket to prevent a fire from departing or entering the tiered storage area.

The spray nozzles may be positioned remotely. By illustration, the first support beam 18 may include a hose 82 which would include a remote nozzle 83 that allows disbursement of the fire extinguishing material in another location. Similarly, the second support beam 50 includes a hose 84, and the third support beam 70 includes a hose 86, all for use in providing a remote nozzle that can be pointed to a particular location. The placement of the nozzles beneath the support beam structure allows for the most through disbursement of material from the support beam, albeit by pressure and gravity. A remote nozzle may include a magnet 85, wherein the nozzle could be attached to one of the uprights 12, 14 or 16, or on the side walls or bottom wall of the support beams. These would allow the installer to determine if there is an optimum area that should be addressed due to possible flammable subject matter that is preferably addressed directly, so as to aid in expediency of extinguishing a hot spot or fire.

It should be noted that three tiers are depicted, consisting of a lower tier 90, a middle tier 92, and an upper tier 94. In larger retail stores, it is not uncommon to find five or more tiers, heavily laden with product, all of which is hidden from main line sprinkler systems. As depicted in the first embodiment, the lower and middle tiers are hidden from a ceiling mounted sprinkler system if anything is placed upon the upper tier 94. The lower tier 90 shows a surface platform 96 that allows for placement of goods, or may consist of numerous layers of plywood, such as that found in a conventional hardware store. The lower tier 96 receives the benefit of support beams, which further provides a support for the middle tier 92. Again, the surface of the middle tier 98, depicted by a single platform, which might be used to support other goods, but for purposes of illustration help define the separate tiers. The lower tier includes support beams that de-replicate the middle tier for ease of illustration, while the middle tier, wherein support beam 18′ provides a fan spray 42′ through spray nozzle 40′. Second support beam 50′ has spray nozzle 58′, providing a conical shaped spray 62′. Third support beam 70′ has a fan shaped spray 80′ as provided through nozzle 78′.

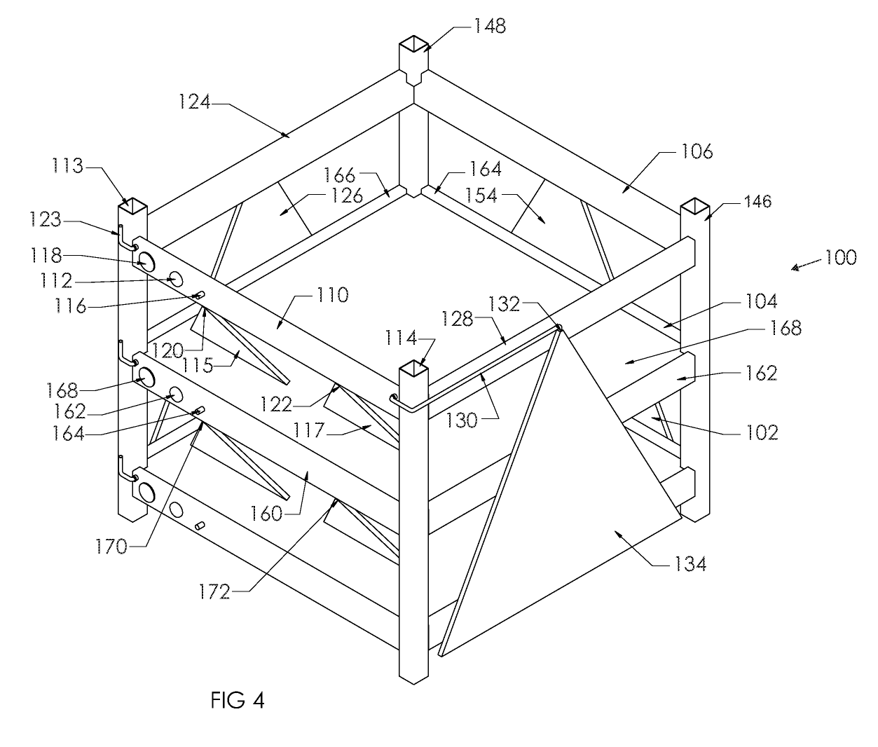

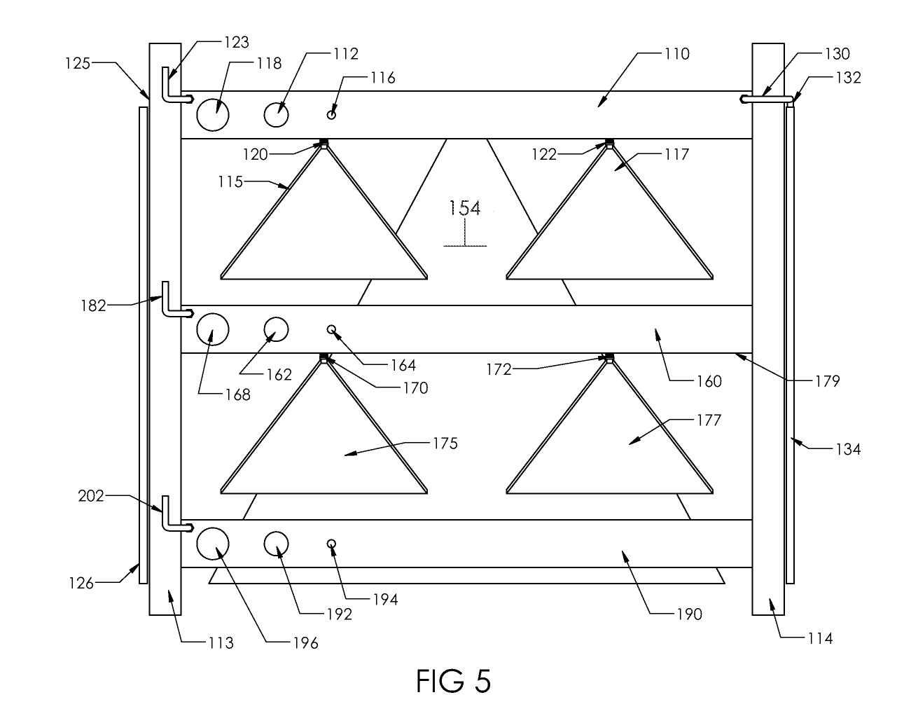

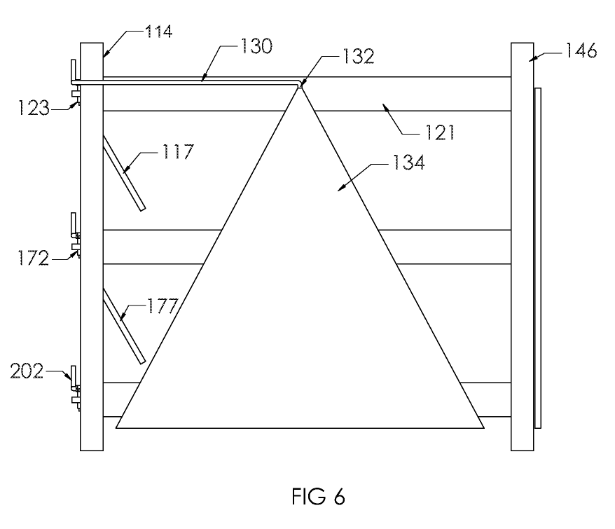

Referring to FIGS. 4 through 6, set forth is an alternative embodiment wherein the support beams provide horizontal support for a storage rack. In this embodiment, the horizontal storage rack system 100 has a lower tier 102, a middle tier 104 and an upper tier 106 with both front stands 113, 114 and rear upright stands 146, 148. As previously mentioned, larger stores may have five or more tiers, and the illustrated three tier system is for illustration purposes only. In this embodiment, a support beam 110 spans between upright stands 113 and 114. Support beam 110 includes an internal chamber that is pressurized upon placement of fire extinguishing material in fill port 112 using an air valve 116 for receipt of compressed gas. The compressed gas may be air, nitrogen or carbon dioxide. The chamber is pressurized and monitored by a pressure gauge 118. Spray nozzles 120 and 122 are placed on a lower wall 121 of the front support beam 110 and have a directional spray 115 & 117 onto the surface of an adjoining surface. In this embodiment, a first hose 123 may be used to direct the fire extinguishing material from the chamber for placement through a remote nozzle 125. In this illustration, the hose 122 may be placed on side support 124 for coupling to a spray nozzle 125 to provide a spray pattern 126 capable of protecting the side of the storage rack. Similarly, side support 128 is illustrated having a hose 130 coupled to the internal chamber within support beam 110 on one end, and a spray nozzle 132 for attachment to the side support 128 along the opposite end. The spray nozzle 132 is depicted as producing a spray pattern 134 essentially providing a side curtain blanket. The back support 106 may also include a nozzle, not shown, to provide spray pattern 154 which can be used to prevent fire from entering or exiting the storage rack.

A second tier 104 can be formed with support beams 160, 162, 164 and 166, with a base 168 interconnecting the support beams. In this illustration, support beam 160 operates as the fire extinguishing support beam positioned between upright supports 113 and 114. It should be noted that the support beams are adjustable along any height of the upright supports. Further, the support beams can be intermixed with support beams that do not include a fire extinguishing system. This allows a store manger to be judicious about placement of the support beams with fire extinguishers for use where storage of products is more likely to cause fuel for a fire. For instance, storage of appliances would be considered no or minimal risk of fire. Storage of Tiki oil and firewood fire starters would be considered high risk. Although not shown, there are many ways of securing the support beam to the upright stands. The ends of the support beams are typically hooked shaped members that are insertable into receptacles formed in the upright support stands.

In this embodiment, a support beam 160 spans between upright stands 113 and 114. The support beam 160 is the same as support beam 110 which includes an internal chamber that is pressurized upon placement of fire extinguishing material in fill port 163 using an air valve 165 for receipt of compressed gas. The chamber is pressurized to a level and monitored by a pressure gauge 168. Spray nozzles 170 and 172 are placed on a lower wall 179 of the front support beam 160 and have a directional spray 175 and 177 onto the surface of an adjoining surface. A hose 182 may be used to direct the fire extinguishing material from the chamber for directional placement through a remote nozzle, similar to support beam 110.

The lower tier 102 is depicted with support beam 190, which is constructed the same as support beams 110 and 160, The support beam 190 will include an internal chamber that is pressurized upon placement of fire extinguishing material in fill port 192 using an air valve 194 for receipt of compressed gas. The chamber is pressurized and monitored by a pressure gauge 196. Support beam 190 may be placed on the lower tier 102 for purposes of protecting the floor, or for use of the remote hose 202 to provide fire extinguisher material to a remote position in accordance with the above description.

In a preferred embodiment, this apparatus utilizes a super absorbent polymer in water in an amount sufficient to extinguish a fire. Examples of these polymers are cross-linked modified polyacrylamides/potassium acrylate or polyacrylamides/sodium acrylate. Other suitable polymers include, albeit are not limited to, carboxy-methylcellulose, alginic acid, cross-linked starches, and cross-linked polyaminoacids. A solid form of the super absorbent polymer is added to water to form an aqueous admixture. The viscosity of the admixture will enable the admixture to remain within a confined area. The properties of the admixture, in particular its viscosity, also enable the admixture to be applied to and remain on vertical, horizontal, and curved surfaces of objects which are on fire or are capable of catching on fire. Adherence of the admixture of super absorbent polymer and water to the surface of an object maintains moisture content at a level which suppresses the spread of the fire by preventing combustion of the object from hot embers and/or flames. In a preferred embodiment, the admixture is sold under the trademark FireIce® and is applied at about 5-8 pounds of FireIce® dry super absorbent polymer added to about 100 gallons of water. Conventional fire extinguisher material may also be placed in the support beams, but it is submitted that the most effective material is the hydrated FireIce® super absorbent polymer.

Storage racks found in retail stores may be adjacent electrical sockets, light fixtures or most any type of electrical device used within a retail store. The hydrated polymer admixture stated herein may come in contact with such electrical components without concern of electrical transfer, as the admixture is non-conductive. In this manner, installation of the apparatus for spraying does not have to be sheltered from electrical equipment. Thus, a substantial financial savings is gained by the present invention because electrical conduits/components which are not on fire are not damaged by admixture.

Storage rack fires present a different and unique problem pertaining to how these fires should be extinguished and suppressed. Water is normally used to fight fires because it can quickly cool down the burning material, there is usually a large supply of it ready for use, and it is relatively inexpensive. However, water has to be placed at the source of the fire. Further, pure water and electricity are harmful, if not deadly, to individuals when brought into contact with each other. Normally, when water hits an active electrical circuit or electrical component, it shorts out the circuit or component, which usually results in destruction of the circuit or component. Further, when individuals are in close proximity to the water contacting the electricity, there is a strong likelihood that the water will act as a conductor and transfer the electricity to the individual. Since water spreads rapidly in all directions on surfaces, electricity which comes in contact with the water will be conducted to wherever the water flows.

Another advantage of the unique method of extinguishing fires is that the hydrated polymer admixture retains ash and other by-products produced by a fire. By entrapping and retaining the ash and other particulates of the fire in a contained mass, the cleanup is facilitated, thus making the cleanup easier and quicker than the cleanup when only water is used to fight a fire. The super absorbent polymer and fire residue can be readily cleaned up by vacuuming or other similar techniques.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fire suppression apparatus tor storage racks comprising:
a support beam formed from a substantially hollow housing having an top wall, a bottom wall, opposing side walls, and two ends to form a chamber capable of withstanding pressure;
a till port releasably secured in one said wall providing access to said chamber;
a fire extinguishing mixture stored within said chamber;
an air valve secured to said support beam, said air valve fluidly coupled to said chamber for receipt of compressed gas for pressurizing said fire extinguishing mixture;
at least one spray nozzle fluidly coupled to said chamber, each said spray nozzle activated by heat for release of said fire extinguishing mixture from said chamber.

2. The fire suppression apparatus for storage racks according to claim 1 wherein said support beam includes a visual indicator of chamber pressure.

3. The fire suppression apparatus for storage racks according to claim 2 wherein said visual indicator is a pressure gauge.

4. The fire suppression apparatus for storage racks according to claim 1 wherein said spray nozzle is adjustable.

5. The fire suppression apparatus for storage racks according to claim 1 including a spray nozzle fluidly coupled to said support beam chamber by a flexible hose.

6. The fire suppression apparatus for storage racks according to claim 5 wherein said spray nozzle includes a magnet for releasably securing said spray nozzle to a support beam.

7. The fire suppression apparatus according to claim 1 wherein said fire extinguishing mixture is a hydrated super absorbent polymer.

8. The fire suppression apparatus according to claim 7 wherein said hydrated super absorbent polymer is FireIce® admixed at a ratio of about 5-8 pounds of dry super absorbent polymer to about 100 gallons of water.
